(19) United States
(12) Patent Application Publication
(10) Pub. No.: US 2013/0212135 A1
(43) Pub. Date: Aug. 15, 2013

(54) COMMUNICATION CONTROL APPARATUS, COMMUNICATION CONTROL METHOD

(71) Applicant: TOSHIBA TEC KABUSHIKI KAISHA, (US)

(72) Inventor: Mika Hara, Shizuoka-ken (JP)

(73) Assignee: TOSHIBA TEC KABUSHIKI KAISHA, Tokyo (JP)

(21) Appl. No.: 13/755,107

(22) Filed: Jan. 31, 2013

(30) Foreign Application Priority Data
Feb. 9, 2012 (JP) 2012-026467

(51) Int. Cl. G06F 17/30

(52) U.S. Cl. CPC G06F 17/30194
USPC 707/827

(57) ABSTRACT

In accordance with an embodiment, a communication control apparatus comprises a storage unit, a property storage unit, a reception unit and a transmission unit. The storage unit stores a file. The property storage unit stores a property information showing attribution of the file for each file stored in the storage unit. The reception unit receives a transmission request of the property information for the file stored in the storage unit from an information processing apparatus connected through a network. The transmission unit sends a screen information to the information processing apparatus, wherein the screen information assembles therein Web parts that serves as a viewer for displaying the file to display the content of the file, and displays thereon the property information of the file instructed by the transmission request.

### CROSS-REFERENCE TO RELATED APPLICATION

This application is based upon and claims the benefit of priority from Japanese Patent Application No. 2012-026467, filed Feb. 9, 2012, the entire contents of which are incorporated herein by reference.

### FIELD

Embodiments described herein relate to a communication control apparatus, and a communication control method.

### BACKGROUND

Formerly, in a case in which the file on a system is displayed, a technology for displaying one or more properties relevant with the selected file is provided. The Explorer (registered trademark) and the like is provided as a software for carrying out such technology. In case that such software is used, there are various ways to display the file.

In recent years, a technology that manages a document on a Web server and refers to the document from a client terminal is provided. In order to manage the document, there is a trend in which a Web application executed on the Web server is used.

Moreover, due to the progress of the Web application, it becomes possible to share documents and to manage projects for a plurality of clients. Each client is capable of referring to various documents managed by the Web application through a browser. Thus, even the document managed on the Web server can be also read with the feeling like the file thereof on the system.

In addition, the Web application executing on the Web server is able to manage not only documents, but also property information relevant with the documents. Thus, the client can read properties of various documents by the browser.

### BRIEF DESCRIPTION OF THE DRAWINGS

FIG. 1 is a network diagram showing a Web server system according to a first embodiment;

FIG. 2 is a block diagram showing compositions of a Web server and an information processing apparatus according to the first embodiment;

FIG. 3 is a diagram showing a table structure of a property storage unit according to the first embodiment;

FIG. 4 is a diagram showing an example of the transition of a webpage generated by a screen generation unit according to the first embodiment;

FIG. 5 is a diagram showing an example of the screen displaying a document library summary according to the first embodiment;

FIG. 6 is a view showing an example of the screen displaying the property of a document according to the first embodiment;

FIG. 7 is a view showing an example of the screen displaying a property setting of a Web parts according to the first embodiment;

FIG. 8 is a time sequence chart showing processing steps of the screen display in the Web server system according to the first embodiment; and

FIG. 9 is a diagram showing hardware compositions of the Web server according to the first embodiment.

### DETAILED DESCRIPTION

In accordance with an embodiment, a communication control apparatus comprises a storage unit, a property storage unit, a reception unit and a transmission unit. The storage unit stores a file. The property storage unit stores a property information showing attribution of the file for each file stored in the storage unit. The reception unit receives a transmission request of the property information for the file stored in the storage unit from an information processing apparatus connected through a network. The transmission unit sends a screen information to the information processing apparatus, wherein the screen information assembles therein Web parts that serves as a viewer for displaying the file to display the content of the file, and displays thereon the property information of the file instructed by the transmission request.

### A First Embodiment

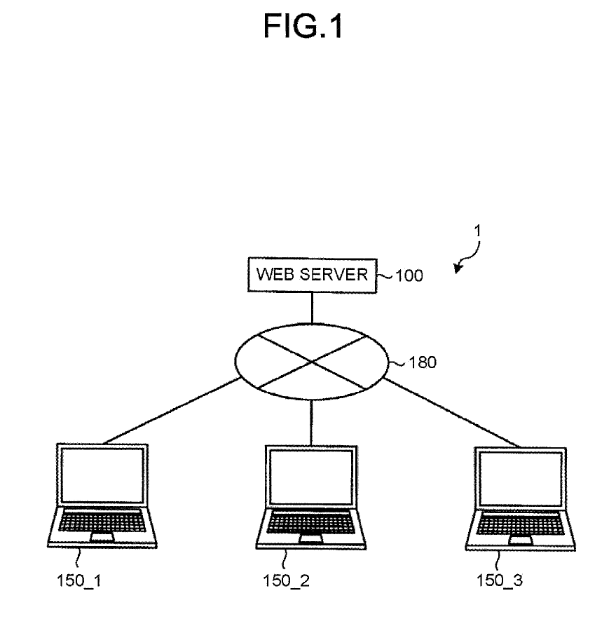

FIG. 1 is a network diagram illustrating a Web server system according to the first embodiment. As shown in FIG. 1, the Web server system 1 according to the present embodiment is equipped with a Web server 100, and information processing apparatuses 150_1, 150_2 and 150_3 all of which are connected through a network 180.

In the case that the reference to a webpage managed by the Web server 100 is desired, the information processing apparatuses 150_1, 150_2 and 150_3 send an HTTP request for displaying the webpage to the Web server 100. Thus, the Web server 100 sends an HTTP response to the information processing apparatuses 150_1, 150_2 and 150_3 in response to the HTTP request. Thus, the information processing apparatuses 150_1, 150_2 and 150_3 can refer to the webpage managed by the Web server 100.

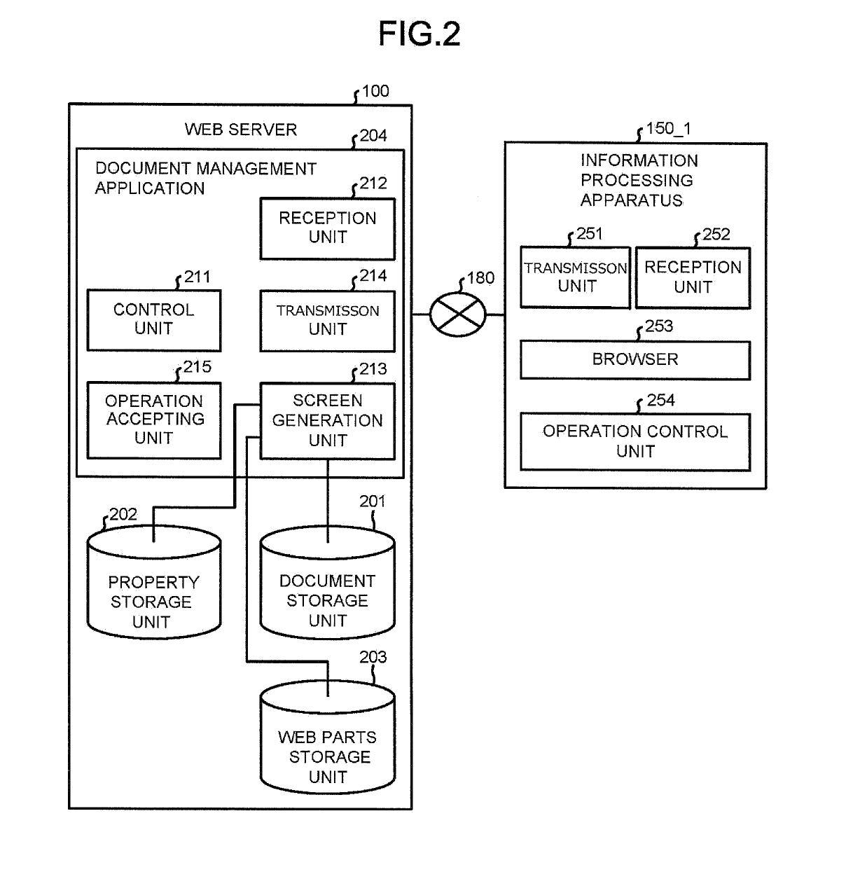

FIG. 2 is a block diagram showing compositions of the Web server 100 and the information processing apparatus 150_1. As shown in FIG. 2, the information processing apparatus 150_1 comprises a transmission unit 251, a reception unit 252, a browser 253 and an operation control unit 254.

The transmission unit 251 sends data to another apparatus (such as the Web server 100) capable of carrying out communication. The transmission unit 251 according to the present embodiment sends the HTTP request for receiving the webpage to the Web server 100.

The reception unit 252 receives the data from the other apparatus (such as the Web server 100) capable of carrying out the communication. For example, in case that the transmission unit 251 sends the HTTP request, the reception unit 252 according to the present embodiment receives the HTTP response including the webpage.

The browser 253 is a software used for displaying the webpage on a display device which is not shown in figures. The browser 253 displays the webpage included in the HTTP response received by the reception unit 252.

The operation control unit 254 accepts an operation by a user through an input device not shown in the figures. The operation control unit 254 accepts an operation to the webpage while the browser 253 displays the webpage. Afterwards, in case that the operation control unit 254 accepts a specified operation, the transmission unit 251 sends the HTTP request corresponding to the operation. Thus, a screen displaying the webpage can be transited.

Next, the Web server 100 is described. The Web server 100 comprises a document storage unit 201, a property storage unit 202, a Web parts storage unit 203 and a document management application 204.

The document storage unit 201 stores text data that the Web server 100 provides to the information processing apparatuses 150_1, 150_2 and 150_3. The forms of the formats of the text data are not particularly limited. However, in order to display the text data on the browser 253, it is required that the Web parts storage unit 203 stores the web part of a viewer corresponding to the format of the text data. In addition, in the present embodiment, an example displaying the text data is described, but the example is not limited to the text data. It is only required that the file can be read by the user.

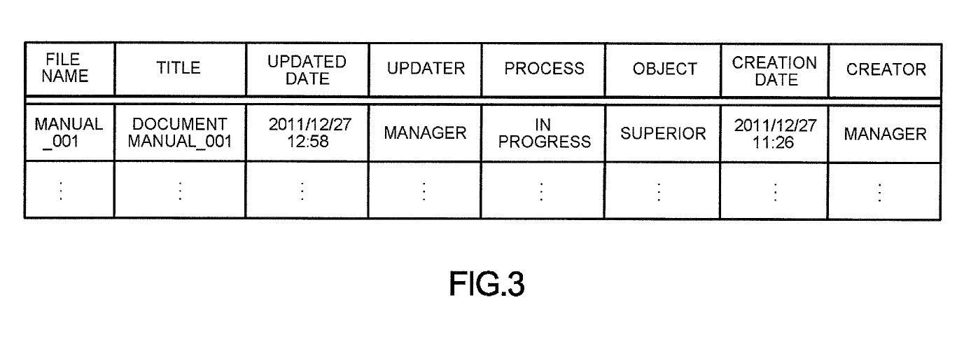

The property storage unit 202 stores the property information showing the attribution of the text data for each of the text data stored in the document storage unit 201. FIG. 3 is a view showing a table structure of the property storage unit 202 according to the present embodiment. As shown in FIG. 3, the property storage unit 202 stores the file name of the text data, the title of the text data, an updated date and time, an updater, a progress, an object of the progress action, a creation date and time and a creator, all of which are associated with one another.

The updated date and time denotes a date and time on which the text data is lastly updated. The updater denotes a user carrying out update on the updated date and time.

The progress is information denoting the progress in the flow of a task using the text data. The object of the progress action denotes a user who should carry out an action in the current progress.

The creation date and time denotes a date and time on which the text data is initially created. The creator denotes a user who initially creates the text data.

In addition, the attribution stored in the property storage unit 202 as the attribution information of the text data is not limited to the above attribution, and the proper attribution can be stored according to the embodiment.

The Web parts storage unit 203 stores the Web parts used when the document management application 204 generates the webpage. The viewer displaying the text data, and the like, are included in the Web parts. In addition, a script created in a script language (such as a JavaScript (registered trademark)), a component using an ActiveX (registered trademark) control and the like, are also included in the Web parts.

The document management application 204 includes a control unit 211, a reception unit 212, a screen generation unit 213, a transmission unit 214 and an operation accepting unit 215.

The document management application 204 collectively manages the text data stored in the document storage unit 201. Moreover, the document management application 204 provides various services utilizing the text data stored in the document storage unit 201 to the information processing apparatuses 150_1, 150_2 and 150_3. The document management application 204 is applied with the share point (registered trademark) provided by the Microsoft corporation (registered trademark), for example.

The document management application 204 dynamically generates the webpage used for referring to the text data. Moreover, the document management application 204 sends the generated webpage to the information processing apparatus 150_1, 150_2 or 150_3.

The document management application 204 according to the present embodiment reads out the property of the text data of a managed object from the property storage unit 202 and uses it for the various services. For example, when the text data is retrieved, the document management application 204 may use the property as a retrieval keyword. In addition, the document management application 204 may generate the webpage describing the property information of the text data and may send it to the information processing apparatus 150_1, 150_2 or 150_3.

In the document management application 204 according to the present embodiment, an example that an ASP file is used as an interface used for calling out an HTML file from the information processing apparatuses 150_1-150_3 is recited. The ASP (Active Server Pages) file is a file in which an HTML and the script are united together.

The information processing apparatuses 150_1-150_3 transmit the HTTP request corresponding to the operation accepted from the user to the Web server 100. Moreover, in case that the ASP file is shown in the HTTP request received from the information processing apparatuses 150_1-150_3, the document management application 204 of the Web server 100 carries out processing corresponding to the script included in the ASP file. When the processing corresponding to the script is carried out, the data may be read out from the document storage unit 201, the property storage unit 202 or the Web parts storage unit 203 to be used. Subsequently, the document management application 204 generates the webpage based on a processing result and the HTML included in the ASP file and sends the HTTP response including the generated webpage to the information processing apparatuses 150_1-150_3.

The control unit 211 carries out the control of all of the document management application 204. For example, the control unit 211 carries out registration, update, cancellation and the like of data to the document storage unit 201, the property storage unit 202 and the Web parts storage unit 203.

The reception unit 212 receives data from the information processing apparatuses 150_1-150_3 connected through the network 180. The data to be received includes the HTTP request showing the transmission request of the webpage.

The screen generation unit 213 analyzes the HTTP request received by the reception unit 212 to carry out the processing corresponding to the script included in the ASP file in case that the ASP file is shown in the HTTP request, and generates the webpage in response to the HTTP request.

The screen generation unit 213 according to the present embodiment extracts the text data needed for generating the webpage, the property (attribution) of the text data, the Web parts and the like from the document storage unit 201, the property storage unit 202 and the Web parts storage unit 203, respectively. Then, the screen generation unit 213 generates the webpage (display screen) using the extracted text data, the property of the text data and the Web parts.

The webpage generated by the screen generation unit 213 includes, for example, a document library summary screen, the property screen of a document and the property setting screen of the Web parts. The document library summary screen displays the summary of a text data name discriminating the text data. The text data displayed as a summary list is able to be read by the user. In addition, the text data is stored in the document storage unit 201.

The property screen of the document displays the property of the text data. The property setting screen of the Web parts is used for carrying out the setting of the Web parts of the property screen. In addition, the webpage generated by the screen generation unit 213 is not limited to the document library summary screen, the property screen of the document and the property setting screen of the Web parts, but another webpage may also be generated.

The transmission unit 214 sends data to the information processing apparatuses 150_1-150_3 connected through the network 180. The data to be sent includes the HTTP response including the webpage generated by the screen generation unit 213.

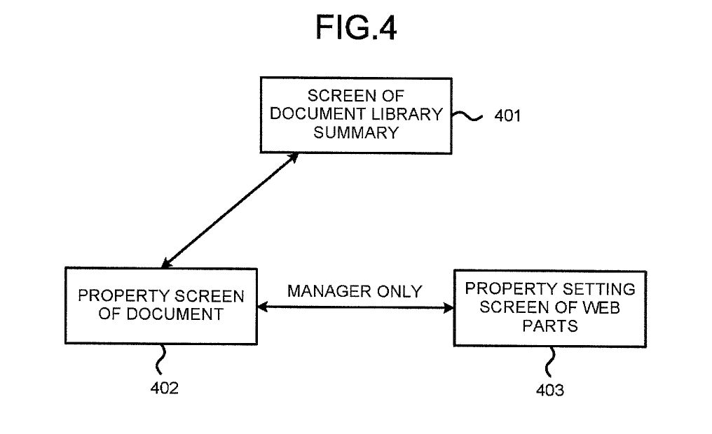

FIG. 4 is a diagram showing an example of the transition of the webpage (display screen) generated by the screen generation unit 213. As shown in FIG. 4, the screen transition is carried out between the document library summary screen 401 and the property screen 402 of the document. In addition, in case that the user is a manager, the screen transition is carried out between the property screen 402 and the property setting screen 403 of the Web parts.

The transmission unit 214 displays the document library summary screen 401 generated by the screen generation unit 213 to the information processing apparatuses 150_1-150_3.

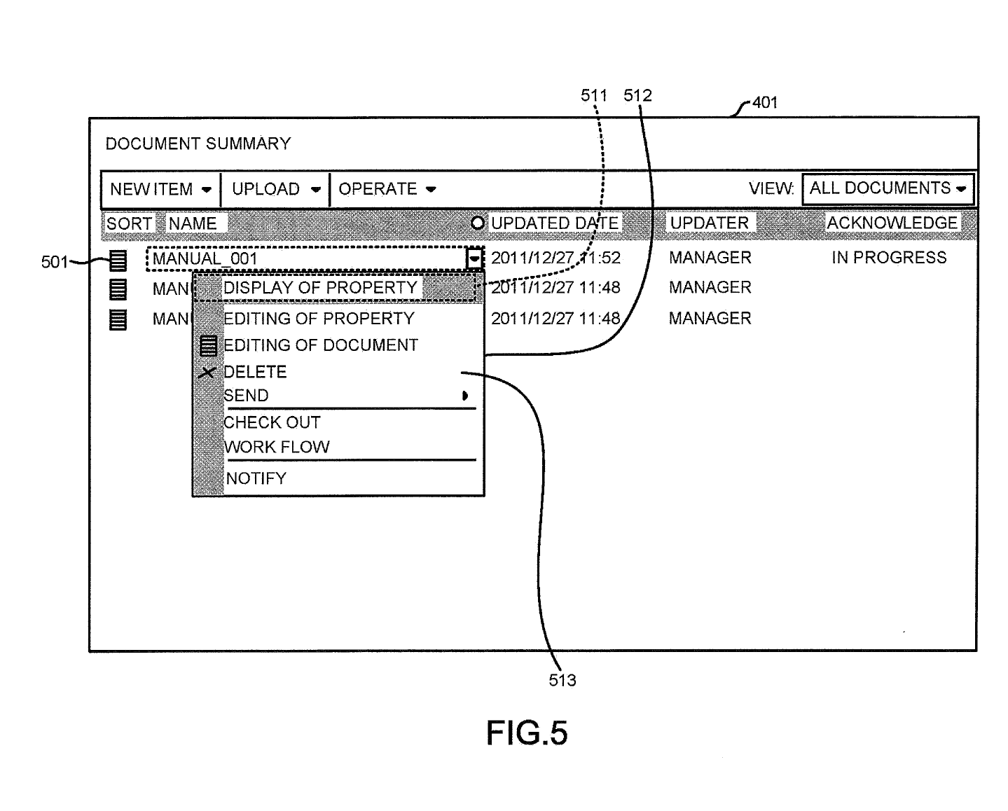

FIG. 5 is a diagram showing an example of the document library summary screen 401. As shown in FIG. 5, the document library summary screen 401 displays the summary of the filename discriminating the text data to which the user can refer. The text data discriminated by the file name is stored in the document storage unit 201.

In the example shown in FIG. 5, the document library summary screen 401 is displayed on the browser 253, and an entry 501 of the text data is in an appointed state. Afterwards, the user can select the display 511 of the property, the edit 512 of the property, the edit 513 of the document, and the like as the operation on the entry 501 (the text data indicated by the entry). Moreover, in case that the operation control unit 254 of the information processing apparatus 150_1 accepts the selection operation of these items, the transmission unit 251 of the information processing apparatus 150_1 sends the HTTP request in response to the selection operation. For example, in if the display 511 of the property is selected, the HTTP request instructing the transmission request of the property screen is sent.

Thus, the reception unit 212 of the Web server 100 receives the HTTP request instructing the transmission request of the property screen. In case that the share point (registered trademark) is used as the document management application 204, the calling out of “Dispform.aspx” is considered as the HPPT request, for example.

Moreover, the screen generation unit 213 generates the property screen 402 of the document in response to the HTTP request received by the reception unit 212 of the Web server 100. The transmission unit 214 sends the property screen 402 of the document, which is generated by the screen generation unit 213, as the HTTP response, to the information processing apparatus 150_1 of a transmission source of the HTTP request.

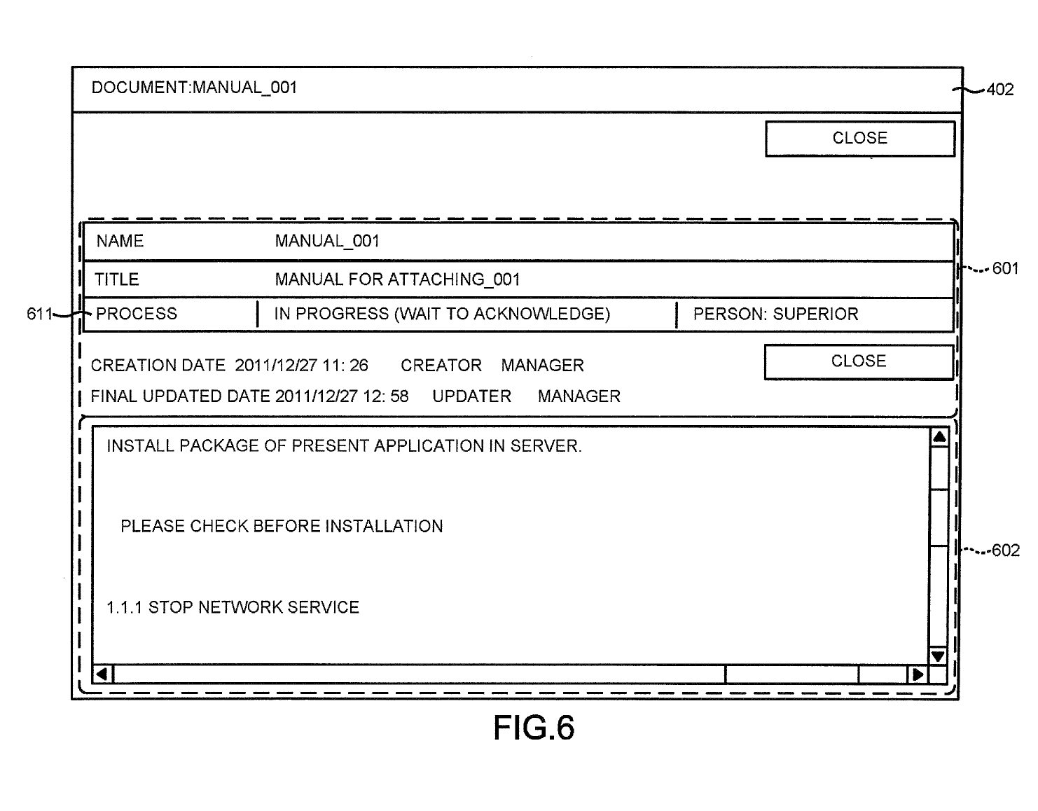

FIG. 6 is a view showing an example of the property screen 402 of the document. As shown in FIG. 6, the summary 601 of the property of the text data appointed by the user on the document library summary screen 401 is displayed on the property screen 402 of the document.

A “name” showing the text data name, the “title”, the “progress”, a “person in charge” who should carry out the action in the progress status, the “creation date”, the “creator”, a “final updated date and time” and the “updater” are arranged on the property screen 402 shown in FIG. 6. These attributions are the attributions stored in the property storage unit 202. In addition, the properties (attributions) displayed on the property screen 402 may be defined by the manger of the Web server 100 from the attributions stored in the property storage unit 202.

The screen generation unit 213 previously assembles the Web parts of the viewer for displaying the text data in a display region 602 on the property screen 402 of the document. Thus, the text data appointed on the document library summary screen 401 is displayed in the display region 602. In this way, the Web parts of the viewer corresponding to the format of the file of a displayed object is previously assembled on the property screen 402.

In addition, the screen generation unit 213 calls out the text data discriminated by the file name included in the HTTP request from the document storage unit 201 to be able to display the content of the text data in the display region 602 by the viewer, and previously assembles the text data in the webpage to be sent to be able to display the text data in the display region 602.

In addition, the screen generation unit 213 generates the property screen 402 on which all pages included in the text data are arranged in case that the text data that is read into consists of a plurality of pages. Thus, when reading the property screen 402, the user can read all the pages included in the text data by scrolling the screen 402 in a downwards direction.

Thus, the Web server 100 according to the present embodiment can display the summary 601 of the property of the text data and the display region 602 in which the content of the text data is described on one screen (property screen 402).

However, formerly, in case that the screen is transited from the document library summary screen to the property screen of the text data, only the property (attribution) of the text data is displayed. Moreover, a link is provided on the property screen as a structure for displaying the content of the text data. Therefore, in order to refer to the content of the text data, the user needs to click the link representing the text data, so as to display the text data on a screen different from the property screen. Therefore, the operation burden is caused to the user, moreover, as the property and the text data are displayed on the different screens, the visibility is reduced, and such a problem that a correspondence relationship between a file and the property of the file is hard to be grasped is also caused when a plurality of windows are displayed.

The document management application 204 according to the present embodiment generates the property screen 402 in which the property information and the viewer for displaying the content of the text data are contained and sends the property screen 402 to the information processing apparatuses 150_1-150_3. Moreover, when the user refers to the property screen 402 from the information processing apparatuses 150_1-150_3, the user can confirms the property and the content of the file at one time, and thus the correspondence relationship therebetween can be grasped.

For example, in a work flow and the like, there is an indispensable case that various persons confirm and acknowledge the content of the file. In the property screen 402 generated by the document management application 204 according to the present embodiment, a field 611 used for managing the progress is arranged. In the field 611, the progress status of the text data and a person in charge subsequently carrying out the action (acknowledgement) on the text data are displayed. In case that the user requesting the HTTP request and the person in charge displayed in the field are the same, the screen generation unit 213 may generate the property screen 402 on which a button and the like used for carrying out the acknowledgement in the field 611 is provided. The confirmation of the content of the text data and the acknowledgement on the text data can be carried out on the property screen 402, thereby being more convenient.

If the user is a manager, the information processing apparatus 150_1 can display the property setting screen 403 of the Web parts. For example, when the browser 253 of the information processing apparatus 150_1 displays the property screen 403, a specified operation from the manager is accepted. In such a condition, the information processing apparatus 150_1 sends the HTTP request corresponding to the operation, and thus, the information processing apparatus 150_1 receives the property setting screen 403 of the Web parts from the Web server 100.

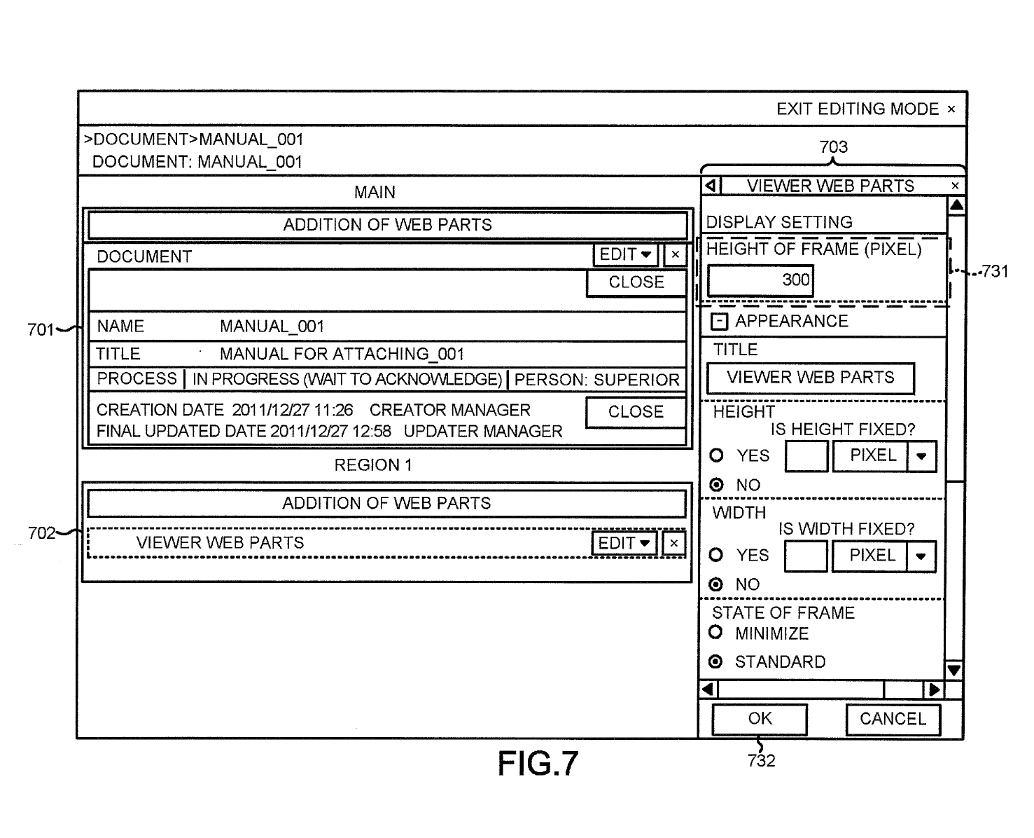

FIG. 7 is a diagram showing an example of the property setting screen 403 of the Web parts. The property setting screen 403 of the Web parts shown in FIG. 7 is used for editing the property screen 402. In the property setting screen 403 of the Web parts shown in FIG. 7, an editing column 701 on a property summary and a column 702 for arranging the Web parts of a file viewer, a window 703 for setting an environment variable for the Web parts of the file viewer are also displayed.

In addition, various kinds of editing which are executed utilizing the property setting screen 403 of the Web parts may be carried out by the information processing apparatuses 150_1-150_3 or may be also carried out by the Web server 100 through the operation accepting unit 215.

The operation accepting unit 215 accepts various operations to the Web server 100. For example, in case that the Web server 100 is displaying the property setting screen 403 of the Web parts, the operation accepting unit 215 accepts the setting of the display size of the Web parts assembled in the property screen 402. For example, in case that an OK button 732 is pressed down after the operation acceptance unit 215 accepts the alteration operation of “the height of a frame (pixel)” displayed in a region 731 on the property setting screen 403 of the Web parts, the control unit 211 sets the environment variable to the Web parts stored in the Web parts storage unit 203 so as to assemble the Web parts of the viewer according to the height of the frame changed and to display the Web parts at the height that is set. In addition, the alteration of “the height of a frame (pixel)” may be accepted by the information processing apparatuses 150_1-150_3 as the HTTP request.

After the environment variable is set, the screen generation unit 213 generates the property screen 402 according to the set variable. Afterwards, the transmission unit 214 sends the generated property screen 402 to the information processing apparatuses 150_1-150_3. As described above, the screen generation unit 213 generates the property screen 402 in which the Web parts based on the display size accepted by the operation accepting unit 215 or the HTTP request is assembled, and the transmission unit 214 sends the generated property screen 402.

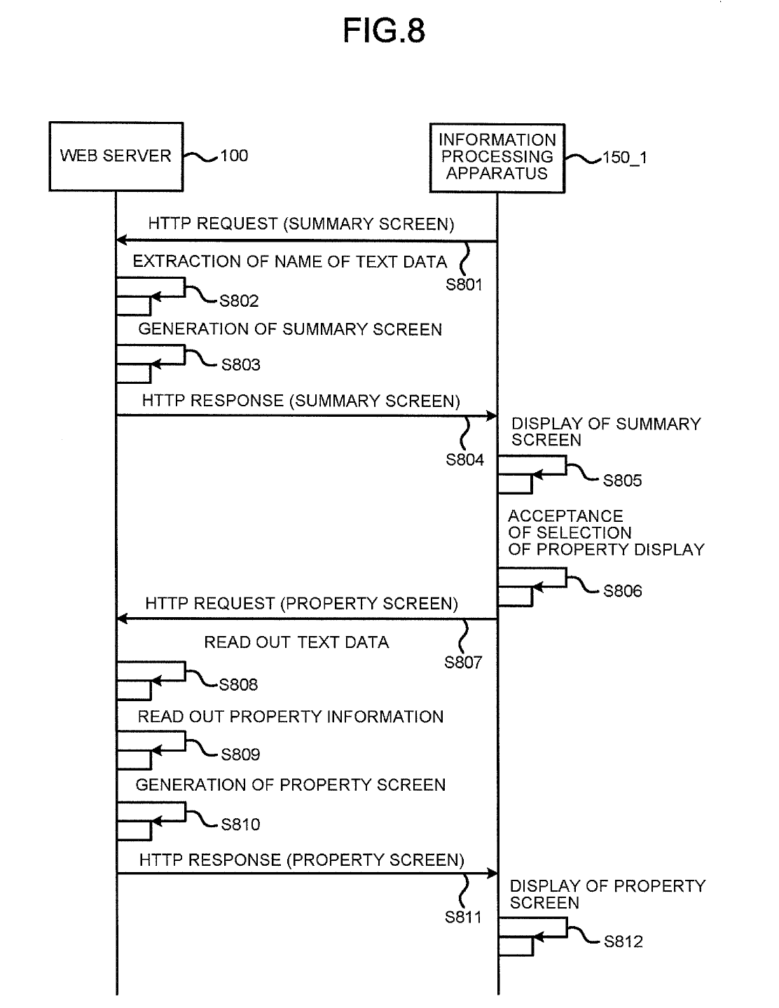

Next, the processing of the screen display in the Web server system 1 according to the present embodiment is described. FIG. 8 is a time sequence chart showing the steps of the above processing in the Web server system 1 according to the present embodiment. In addition, in the present time sequence chart, the processing between the Web server 100 and the information processing apparatus 150_1 is described, but the processing between the Web server 100 and another information processing apparatus (such as the information processing apparatuses 150_2 and 150_3) is also the same, and therefore, the description thereof is omitted.

First, the transmission unit 251 of the information processing apparatus 150_1 sends the HTTP request representing the transmission request of the document library summary screen 401 to the Web server 100 (ACT S801).

Along with the reception of the HTTP request, the screen generation unit 213 of the Web server 100 extracts the name of the text data from the document storage unit 201 (ACT S802). In addition, the screen generation unit 213 may also extract the file name of the text data from the property storage unit 202.

Subsequently, the screen generation unit 213 generates the document library summary screen 401 including the summary of the extracted name of the text data (ACT S803).

Afterwards, the transmission unit 214 sends the HTTP response including the generated document library summary screen 401 to the information processing apparatus 150_1 (ACT S804).

In the information processing apparatus 150_1 receiving the HTTP response, the browser 253 displays the document library summary screen 401 (ACT S805). Subsequently, after the operation control unit 254 accepts the selection to the text data forming the displayed object from the document library summary screen 401, the selection to the “property display” is accepted (ACT S806).

Afterwards, the transmission unit 251 sends the HTTP request for displaying the property screen 402 of the document relevant with the selected text data to the Web server 100 (ACT S807). If the share point is used, the “DispForm.aspx” is called as the HTTP request for displaying the property screen 402 of the document, for example.

After the HTTP request is received, the screen generation unit 213 of the Web server 100 reads out the selected text data (ACT S808). Afterwards, the screen generation unit 213 reads out the property information of the text data from the property storage unit 202 (ACT S809).

Subsequently, the screen generation unit 213 reads out the Web parts (such as the viewer for the text data) used for generating the property screen 402 of the document from the Web parts storage unit 203 and generates the property screen 402 of the document based on the Web parts read out, the text data and the property information (ACT S810).

Afterwards, the transmission unit 214 of the Web server 100 sends the HTTP response including the generated property screen 402 of the document (ACT S811).

Subsequently, the browser 253 of the information processing apparatus 150_1 displays the received property screen 402 of the document (ACT S812).

By the above processing, the browser 253 can display the property screen 402 arranging thereon the property of the text data and the content of the text data at the same time, and therefore, the user can confirm the content and the property of the file at one time.

Formerly, the content of the file is confirmed by clicking the link of the file from the property screen, but in the present embodiment, since the content of the file can be confirmed while the property thereof is confirmed, the operation burden can be decreased, and moreover, the convenience for the user can be improved.

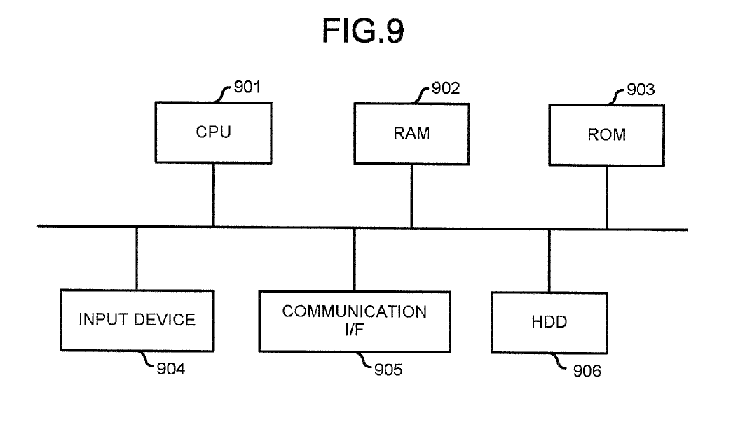

FIG. 9 is a diagram showing hardware compositions of the Web server 100. As shown in FIG. 9, the Web server 100 comprises a CPU 901, a RAM 902, a ROM 903, an input device 904, a communication I/F 905 and an HDD 906, all of which are hardware components utilizing an ordinary computer.

The document management application executed by the Web server 100 of the present embodiment is provided in the form of a file in an installable or an executable such that it is recorded in a computer-readable recording medium such as a CD-ROM, a flexible drive (FD), a CD-R, a DVD (Digital Versatile Disk) and the like.

In addition, it may be provided such that the document management application executed by the Web server 100 of the present embodiment is stored in the computer connected with the network such as an internet and the like and is downloaded through a network. In addition, the document management application executed by the Web server 100 of the present embodiment may also be provided or distributed through the network path such as the internet and the like.

Still, it may also be provided such that the document management application of the present embodiment is previously assembled in the ROM and the like.

The document management application executed by the Web server of the present embodiment is a module composition including all the above units (the control unit, the reception unit, the screen generation unit, the transmission unit and the operation accepting unit). In an actual hardware, the CPU 901 reads out the document management application from the above storage medium to execute it, and thus all the above units are downloaded on a master storage device (RAM 902) to form the control unit, the reception unit, the screen generation unit, the transmission unit and the operation accepting unit on the master storage device (RAM 902).

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A communication control apparatus, comprising:
a storage unit configured to store a file;
a property storage unit configured to store a property information showing attribution of the file for each file stored in the storage unit;
a reception unit configured to receive a transmission request of the property information for the file stored in the storage unit from an information processing apparatus connected through a network; and
a transmission unit configured to send a screen information to the information processing apparatus, wherein the screen information assembles therein Web parts that serves as a viewer for displaying the file to display the content of the file, and displays thereon the property information of the file instructed by the transmission request.

2. The apparatus according to claim 1, wherein the transmission unit sends a summary screen information displaying a summary of a data discrimination information for discriminating the file stored in the storage unit to the information processing apparatus, and the reception unit receives the transmission request of the property information for the file which is discriminated based on the data discrimination information included in the summary screen information.

3. The apparatus according to claim 1, further comprising:
an accepting unit configured to accept the setting of a display size of the Web parts assembled in the screen information transmitted by the transmission unit, wherein
the transmission unit sends the screen information in which the Web parts is assembled according to the display size accepted by the accepting unit.

4. The apparatus according to claim 2, further comprising:
an accepting unit configured to accept the setting of a display size of the Web parts assembled in the screen information transmitted by the transmission unit, wherein
the transmission unit sends the screen information in which the Web parts is assembled according to the display size accepted by the accepting unit.

5. The apparatus according to claims 1, wherein
the property storage unit also stores a progress information in the flow of a task using the file and the transmission unit sends the screen information including the progress information.

6. A communication control method, executed by a communication control apparatus which comprises a storage unit configured to store a file, a property storage unit configured to store a property information indicating an attribution of each file stored in the storage unit, a receiving unit and a transmission unit, comprising:
receiving a transmission request of the property information of the file stored in the storage unit by the receiving unit from an information processing apparatus connected through a network; and
transmitting a screen information from the transmission unit to the information processing apparatus, wherein the screen information assembles therein Web parts that serves as a viewer for displaying the file to display the content of the file, and displays thereon the property information of the file instructed by the transmission request.
